(19) United States
(12) Patent Application Publication
(10) Pub. No.: US 2026/0257895 A1
(43) Pub. Date: Sep. 3, 2026

(54) Assisting an Operator to Handle a Crane of a Container Lifting System

(71) Applicant: ABB Schweiz AG, Baden (CH)

(72) Inventors: Dawid Ziobro, Västerås (SE); Gayathri Gopalakrishnan, Eskilstuna (SE); Simon Hallstadius Linge, Västerås (SE)

(73) Assignee: ABB Schweiz AG, Baden (CH)

(21) Appl. No.: 19/373,239

(22) Filed: Oct. 29, 2025

(30) Foreign Application Priority Data
Oct. 29, 2024 (EP) 24209546

(51) Int. Cl. B66C 13/46; B66C 15/06

(52) U.S. Cl. CPC B66C 13/46; B66C 15/065

(57) ABSTRACT

A method for assisting an operator to handle a crane of a container lifting system includes using a container lifting management device that displays a progress indicator to the operator. The progress indicator shows representations of a number of sequential steps being performed by the crane in an operations cycle, obtains sensor data of the crane at a current point in time during the operations cycle, determines a current step of the operations cycle that the crane currently performs and how much of the current step the crane has completed based on the sensor data and indicates the progress at the current point in time in the representation of the current step of the progress indicator.

### CROSS-REFERENCE TO RELATED APPLICATIONS

The instant application claims priority to European Patent Application No. 24209546.1, filed October 29, 2024, which is incorporated herein in its entirety by reference.

### FIELD OF THE DISCLOSURE

The present disclosure generally relates to a method, computer program and computer program product for assisting an operator to handle at least one crane of a container lifting system, a container lifting management device as well as a container lifting system.

### BACKGROUND OF THE INVENTION

As crane systems become more intelligent their abilities extend providing new opportunities to make crane operations more autonomous. For a crane operator this might imply a smaller workload or need for manual intervention, but there are dangerous side effects like boredom and meaningless supervision tasks. The challenge arises in how to create a meaningful job with stimulating tasks. A solution addressing that problem is to channel workload from multiple cranes and assign operator(s) to simultaneously supervise multiple cranes.

CN102491206 does for instance describe a tower crane monitoring system, which comprises single-crane monitoring units and a multiple-crane centralized monitoring unit. The single-crane monitoring units are used for onsite monitoring management of single tower cranes and transmitting the monitoring information to the multiple-crane centralized monitoring unit and connected with a GPRS (general packet radio service) public network. The multiple-crane centralized monitoring unit is used for monitoring information of all the onsite single-crane monitoring units in a centralized manner and controlling onsite tower cranes,

However, there is room for improvement in the way that the supervision of a crane is made, especially if the monitoring is to be scaled up to several cranes.

### BRIEF SUMMARY OF THE INVENTION

The present disclosure generally describes systems and methods for improving the way supervision of a crane is made in a container lifting system. In one aspect, the disclosure describes a method for assisting an operator to handle a crane of a container lifting system, the method being perfonned by a container lifting management device and comprising: displaying a progress indicator to the operator, which progress indicator shows representations of a number of sequential steps being performed by the crane in an operations cycle, obtaining sensor data of the crane at a current point in time during the operations cycle, determining a current step of the operations cycle that the crane currently performs and how much of the current step the crane has completed based on the sensor data, and indicating the progress at the current point in time in the representation of the current step of the progress indicator.

In another aspect, the disclosure describes a container lifting management device comprising a processor operative to: display a progress indicator to an operator, which progress indicator shows representations of a number of sequential steps being performed by a crane in an operations cycle, obtain sensor data of the crane at a current point in time during the operations cycle, determine a current step of the operations cycle that the crane currently performs and how much of the current step the crane has completed based on the sensor data, and indicate the progress at the current point in time in the representation of the current step of the progress indicator.

In yet another aspect, the disclosure describes a container lifting system comprising the crane, a crane control device controlling the crane and the container lifting management device according to another aspect. In yet another aspect, the disclosure describes a computer program for assisting an operator to handle a of a container lifting system, the computer program comprising computer program code which when run by a processor causes the processor to: display a progress indicator to an operator, which progress indicator shows representations of a number of sequential steps being performed the crane in an operations cycle, obtain sensor data of the crane at a current point in time during the operations cycle, determine a current step of the operations cycle that the crane currently performs and how much of the current step the crane has completed based on the sensor data, and indicate the progress at the current point in time in the representation of the current step of the progress indicator.

In yet another aspect, the disclosure describes a computer program product for assisting an operator to handle a crane of a container lifting system, the computer program product comprising a data carrier with the computer program according to another aspect.

### BRIEF DESCRIPTION OF THE SEVERAL VIEWS OF THE DRAWING(S)

FIG. 1 is a schematic of a container lifting system comprising a group of cranes, each connected to a corresponding crane control device, a number video capturing systems, each associated with a corresponding crane, as well as a container lifting management device, in accordance with the disclosure.

FIG. 2 is a schematic of a first video capturing system and a number of video streams that it provides in accordance with the disclosure.

FIG. 3 is a diagram of a realization of the container lifting management device in accordance with the disclosure.

FIG. 4 is a view of a computer program product in the form of a CD ROM with computer program code used to implement a container lifting management function of the container lifting management device in accordance with the disclosure.

FIG. 5 is a schematic of a container vessel to or from which a container is being lifted using a crane in accordance with the disclosure.

FIG. 6 is a diagram of a progress indicator for the crane presented in a supervisory mode to an operator by the container lifting management device in accordance with the disclosure.

FIG. 7 is a flowchart of a first number of method steps in a method of assisting an operator to handle the crane of the container lifting system in accordance with the disclosure.

FIG. 8 is a diagram of a progress indicator for the crane presented to the operator by the container lifting management device in a manual intervention mode in accordance with the disclosure.

FIG. 9 is a flowchart of a second number of method steps in the method of assisting an operator to handle the crane of the container lifting system in accordance with the disclosure.

FIG. 10 is a flowchart of a third number of method steps in the method of assisting an operator to handle the crane of the container lifting system in accordance with the disclosure.

### DETAILED DESCRIPTION OF THE INVENTION

In the following description, for purposes of explanation and not limitation, specific details are set forth such as particular architectures, interfaces, techniques, etc. in order to provide a thorough understanding of the invention. However, it will be apparent to those skilled in the art that the invention may be practiced in other embodiments that depart from these specific details. In other instances, detailed descriptions of well-known devices, circuits and methods are omitted so as not to obscure the description of the invention with unnecessary detail.

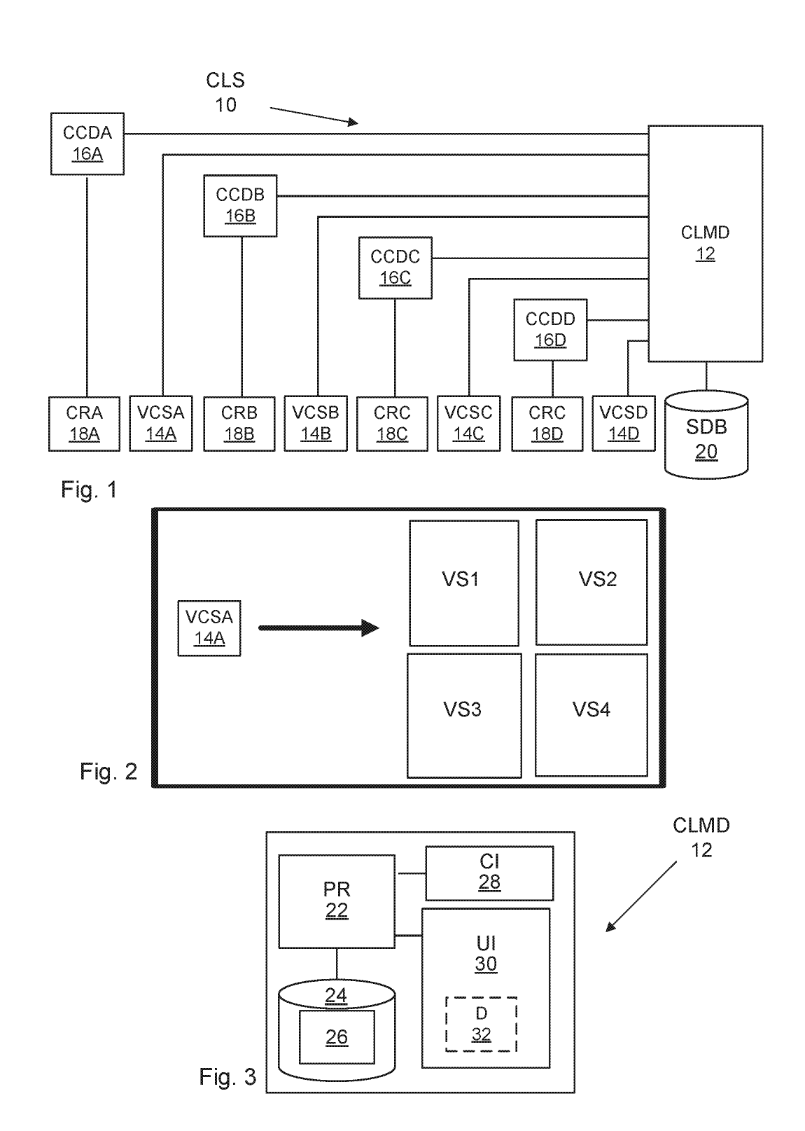

The present disclosure generally describes systems and methods for assisting an operator of a container lifting system with regard to a crane of the system. FIG. 1 schematically shows a container lifting system 10 that comprises a container lifting management device CLMD 12, a group of cranes, a group of crane control devices and a group of video capturing systems. As an example, there is a first crane CRA 18A connected to a first crane control device CCDA 16A, a second crane CRB 18B connected to a second crane control device CCDB 16B, a third crane CRC 18C connected to a third crane control device CCDC 16C and a fourth crane CRD 18D connected to a fourth crane control device CCDD 16D. The first crane control device 16A controls the first crane 18A, the second crane control device 16B controls the second crane 18B, the third crane control device 16C controls the third crane 18C and the fourth crane control device 16D controls the fourth crane 18D.

There is also a group of video capturing systems 14A, 14B, 14C, 14D, each being associated with a corresponding crane 18A, 18B, 18C, 18D in the group of cranes. Thus, there is a first video capturing system VCSA 14A associated with the first crane 18A, a second video capturing system VCSB 14B associated with the second crane 18B, a third video capturing system VCSC 14C associated with the third crane 18C and a fourth video capturing system VCSD 14D associated with the fourth crane 18D. Each video capturing system may comprise one or more video cameras mounted on or at the corresponding crane and at least one video camera is mounted on the corresponding crane and provides a primary video stream having a field of view covering at least a part of the crane, such as a spreader of the crane.

The group of cranes comprises the first crane 18A, the second crane 18B, the third crane 18C and the fourth crane 18D, the group of crane control devices comprises the first crane control device 16A, the second crane control device 16B, the third crane control device 16C and the fourth crane control device 16D, while the group of video capturing systems comprises the first video capturing system 14A, the second video capturing system 14B, the third video capturing system 14C and the fourth video capturing system 14D.

There may be further video capturing systems present, such as a quay video system covering one or more quays at which the cranes operate. The crane control devices 16A, 16B, 16C, 16D and the video capturing systems 18A, 18B, 18C, 18D are all connected to the container lifting management device 12. There may also be more as well as fewer cranes and crane control devices. In its simplest form the container lifting system 10 may comprise only one crane, a corresponding crane control device and the container lifting management device.

A crane control device may be a controller, such as a Programmable Logic Controller (PLC) used to control the operation of a corresponding crane, like controlling the crane to lift or hoist objects like containers. The container lifting management device 12 is optionally also connected to a step database SDB 20.

Each video capturing system may provide several video streams that are associated with the operation of a corresponding crane. FIG. 2 shows four different video streams provided by the first video capturing system 14A. As an example, the first video capturing system 14A provides, perhaps together with the previously mentioned quay video system, a first video stream V1, a second video stream VS2, a third video stream VS3 and a fourth video stream VS4.

FIG. 3 schematically shows one realization of the container lifting management device CLMD 12. The container lifting management device 12 comprises a processor PR 22 and a data storage 24 with a computer program 26 comprising computer program instructions that, when executed by the processor 22, implements a container lifting management function. There is also a first communication interface CI 28, here realized as an Ethernet interface, for communicating with the crane control devices 16A, 16B, 16C, 16D and video capturing systems 14A, 14, 14C, 14D.

The processor 22 is also connected to a user Interface UI 30 or HMI (Human Machine Interface) via which an operator may make inputs and be presented with information about the operation of the crane lifting system 10. For this reason, the user interface 30 may comprise a display D 32, which may with advantage be realized as a touchscreen. However, it is also possible that the user interface comprises other means of inputting data such as a keyboard, a keypad, joystick and/or a track ball.

The container lifting management device 12 may thus comprise a processor 22 with associated program memory 24 including a computer program 26 with computer program code for implementing the container lifting management function.

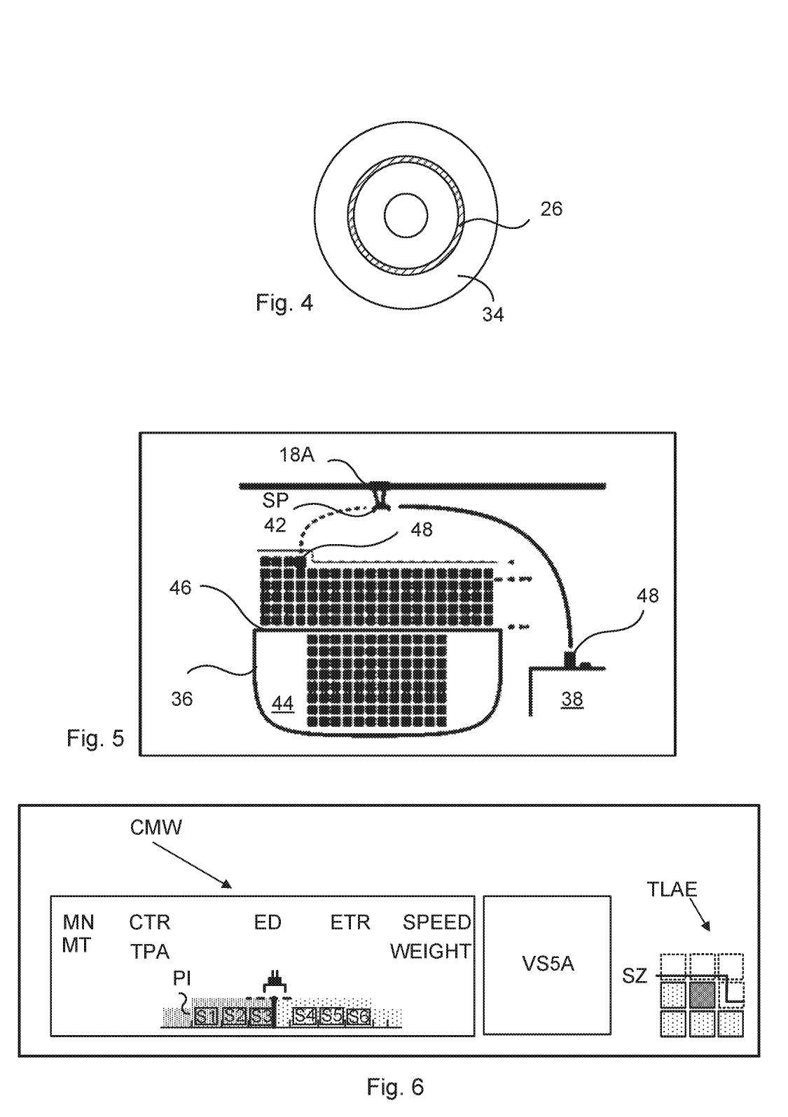

A computer program may also be provided via a computer program product, for instance in the form of a non-transitory computer readable storage medium or data carrier, like a CD ROM, a memory stick or a memory card, carrying such a computer program with the computer program code, which will implement the container lifting management function when being run by a processor. One such computer program product in the form of a CD ROM 34 with the above-mentioned computer program 26 comprising computer program code is schematically shown in FIG. 4.

FIG. 5 schematically shows the first crane 18A that moves a container 48 to or from a cargo vessel 36. As can be seen in FIG. 5, the first crane 18A may be equipped with a spreader SP 42 used to move a container 48 from a quay 38 to a cargo vessel 36 or from the cargo vessel 36 to the quay 38, where the container 48 may be lifted from or to a road chassis of a truck on the quay 38 and where the lifting may be done using flippers of the spreader 42. It is possible that a container is placed inside a hatch 44 or on a deck 46 of the cargo vessel 36. To be placed inside the hatch 44, it may be necessary to open hatch covers. Furthernore, a container may be locked to the vessel, other containers and/or road chassis using locking mechanisms such as twist locks.

The lifting of containers to or from a cargo vessel using cranes is according to the present disclosure in normal cases made automatically under the control of crane control devices and where one or more operators may supervise this operation. The container lifting management device 12 may provide a supervisory mode in which an operator may get an overview of the automatic crane control of a group of cranes. It may also provide other modes of which at least some can be selected by the operator.

When the operator supervises several cranes, it will be challenging to quickly overview the status of all those cranes. Currently to gather the status information for multiple cranes, the operator must separately navigate to multiple screens/windows. There is no comprehensive overview that allows the quick interpretation of multiple cranes statuses. To facilitate faster overview of the operational process for several cranes it would be advantageous when the information is condensed and visualized in a new way. Currently such a representation does not exist. Aspects of the present disclosure are directed towards such visualization improvement.

Aspects of the present disclosure are directed towards providing a progress indicator for displaying information about a crane. The proposed progress indicator for a crane has a structure allowing it to be easily combined with progress indicators for other cranes. Thus, it is possible to combine several progress indicators on a display in order to display information about several cranes.

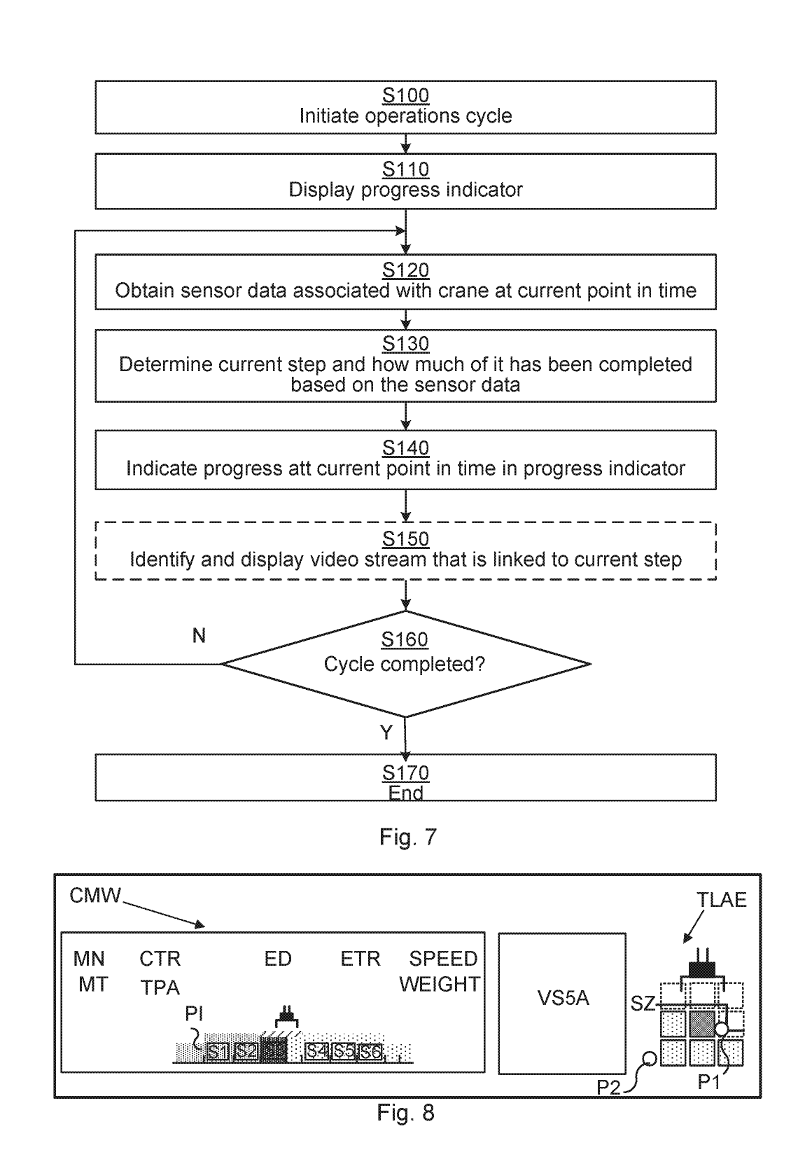

These aspects will now be described in more detail with reference being made also to FIG. 6 and 7, where FIG. 6 schematically shows a progress indicator for a crane presented in a supervisory mode to an operator by the container lifting management device and FIG. 7 shows a flow chart of a first number of method steps in a method of assisting an operator to handle the first crane of the container lifting system.

The container lifting management function of the container lifting management device may provide a number of progress indicators, one for each crane in a group of cranes being monitored by the operator.

FIG. 6 shows a current move window CMW provided for a crane, which as an example is provided for the first crane 18A. The current move window CMW is provided for a current move being performed in a current cycle of operation of the crane, i.e. in a current operations cycle. The current move window CMW comprises a progress indicator PI as well as additional data, where the additional data may include data such as Move Number MN, move type MT, container CTR being handled, a first target area of the container that as an example is a target placing area TPA, estimated duration ED of the move, estimated time remaining ETR of the move, speed of the crane/spreader and weight of the container that is handled during the move. The move number MN may be the number in a set of moves being defined in a work order for the crane, and the move type may be a move among a number of types of moves, such as discharge below deck, discharge above deck, load above deck, load below deck, opening hatch covers and closing hatch covers. The estimated duration ED may be the time that the move is estimated to take, while the estimated time remaining ETR may be the time estimated to remain from a current point in time in the operations cycle to a time at which the move is completed.

The progress indicator PI, which is an indicator of the progress of the current cycle, may show representations of a number of consecutive or sequential steps being performed by the crane in the operations cycle, where each representation may for instance be shown along a first, possibly horizontal progression line. The representations of the steps may as an example be shown as a number of rectangular shaped areas provided along the first progression line. The progress indicator PI may also indicate which step the crane is currently perforning as well as how far the crane has progressed in the step. The progress may be signaled through a second line that is perpendicular to the first line and that moves along the first progression line as the step is being perfonned, which movement may be from left to right. Thereby, the second line may move along the first line during the consecutive steps in the cycle.

Each step may be shown as having one of two heights or levels above the first line, where a first height or level above the first line indicates that the crane is above a quay and a second height or level above the first line indicates that the crane is above a cargo vessel, or vice versa.

The progress indicator may further comprise symbols representing at least some of the steps. These symbols may be shown in the rectangular shaped areas of these steps. The symbols may for instance be realized as icons. Thus, at least some of the steps may also comprise symbols indicating the type of operation being made in the step. A symbol may also be omitted from a step, for instance if the same operation is performed in the step as in a previous or following step.

The operations may include the operations moving a crane between a quay and a cargo vessel for reaching a target lifting area, which movement may be divided into two steps one above the quay and the other above the cargo vessel, lowering the spreader of the crane to a target lifting area, locking the spreader to a container at the target lifting area, identifying the container at the target lifting area, raising the spreader and moving the crane with the container between the cargo vessel and the quay for reaching a target placing area, which movement may likewise be divided into two steps, one above the quay and another above the vessel. Similar types of movements and symbols may exist for opening and closing a hatch.

Thereby the different steps may be of different types, such as the types moving a crane, above a quay, between the quay and a cargo vessel for reaching a first target handling area, moving the crane, above the cargo vessel, between the quay and the cargo vessel for reaching the first target handling area, Lowering the spreader of the crane to the first target handling area, locking the spreader to a container at the first target handling area, identifying a container at the first target handling area, raising the spreader with container from the first target handling area, moving the crane with the container, above the cargo vessel, between the cargo vessel and the quay for reaching a second target handling area, moving the crane with the container, above the quay, between the cargo vessel and the quay for reaching the second target handling area, opening a hatch at the first or second target handling area and closing a hatch at the first or second target handling area.

The first target handling area may be a target lifting area that may be either on the quay or on the cargo vessel and the second target handling area may be a target placing that may be either on the vessel or on the quay. A target area on a vessel can additionally be above or below deck. The first target area may additionally be the area of a hatch on a cargo vessel.

Moreover, at least some of the steps performed by the crane in the operations cycle are linked to video streams of the corresponding video capturing system. Thus, a step may be linked to a video stream. It may more particularly be linked to only one video stream.

In the example of FIG. 6 the move is a move where a container is to be taken from a cargo vessel and be placed on a quay. Therefore, there is a first step of moving the crane without container from above the quay, a second step of continuing moving the crane without container above the cargo vessel, which is indicated using a first symbol Si, a third step of lowering the spreader of the crane to a target area on the cargo vessel, which is indicated by a second symbol 52, a fourth step of locking a container at the target area of the cargo vessel to the crane spreader, which is indicated by a third symbol S3, a fifth step of identifying the container, for instance through the reading of a bar or QR code that is indicated by a fourth symbol S4, a sixth step of raising the crane spreader with the container from the target area on the cargo vessel, which is indicated through a fifth symbol S5. There is also a moving of the crane with container from the cargo vessel to the quay, where the movement above the cargo vessel is performed in a seventh step and indicated with a sixth symbol S6 and the movement above the quay is performed in an eighth step. It should here be realized that there may be further steps, such as lowering the container to a target area on the quay and releasing the container in this target area.

In addition to the current move window, it is additionally possible to show a view of a current target area environment, i.e. an environment of a target area in which the container being handled in the cycle is to be placed or from where it is to be lifted. Put differently, a target area is an area that is to be handled, where the handling involves placing a container in the target area or lifting a container from the target area.

This view of the environment of the current target area may also show neighboring container areas, which container areas may be shown as previous target areas having already been handled and/or following target areas that are about to be handled, where a previous target area is an area that was a target area before the current target area, i.e. in a previous cycle, and a following target area is a target area that will be handled in the future, i.e. an area that will become a target area after the current target area. There may also be a safety zone SZ around the current target area, which safety zone may consider if the neighboring target areas are previous or following target areas. Thus, the target area may be displayed together with previous and following target areas and a safety zone.

In the example in FIG. 6, the target area is a target lifting area on the cargo vessel, i.e. a target area on the cargo vessel from where a container is to be lifted. Thus, there is a shown a target lifting area environment TLAE.

In addition to the current move window CMW and target lifting area environment TLAE, it is additionally possible to shown one of the video streams of the associated video capturing system. In the example of FIG. 6, the fourth video stream VS4 of the first video capturing system 14A is shown.

Furthermore, the different video streams provided by the first video capturing system may cover different areas. For instance, the first video stream VS1 may cover the quay, the second video stream VS2 may cover the deck of the cargo vessel, the third video stream VS3 may cover the loading target area at a first zoom level and the fourth video stream VS4 may cover the loading target area with a second zoom level. It is additionally possible that at least some of the steps performed by the crane in the operations cycle are each linked to a video stream. As an example, the first video stream VS1 may be linked to the first and eighth steps, the second video stream VS2 may be linked to the second and seventh steps, the third video stream VS3 may be linked to the third and sixth steps and the fourth video stream VS4 may be linked to the firth and fifth steps.

The operation may be started through the initiation of an operations cycle, S100, which may be the crane starting to perform a move in an operations cycle. This may trigger the container lifting management function of the container lifting management device to display the progress indicator PI to the operator, S110, which may involve displaying the different steps as well as the symbols that are associated with one or more of these steps.

The crane may also operate in a supervisory mode in which the crane is controlled by the crane control device and the operator is merely monitoring the operations of the crane.

The container lifting management function may have knowledge about the duration time of previous cycles. This may be used to estimate the duration of the current cycle ED. It may also predict the duration of the current move based on one or more moves of previous cycles.

The container lifting management function may also obtain sensor data associated with the crane at a current point in time during the operation of the operations cycle, S120.

A crane may be equipped with several sensors, and the crane may supply signals of these sensors to the corresponding crane control device. Also, different views of the crane and target areas may be provided by the video capturing system associated with the crane. One or more of these views may also cover the crane spreader. A crane control device may control a corresponding crane based on such sensor signals. The operation is typically cyclical and specified in a work order. Therefore, a crane control device may control a crane to move a crane spreader to a target lifting area, identify a container at the target lifting area, lock the spreader to the container, move the container from the target lifting area to a target delivery area, place the container at the target delivery area and unlock the spreader from the container. Another type of cycle involves moving the crane spreader to a hatch and opening or closing the hatch. One of the target areas is typically an area on a cargo vessel, such as an area on or below deck of the vessel and the other target area is typically an area on a quay, for instance on a road chassis located on the quay.

The container lifting management function may use this sensor data to determine how far into the cycle the crane has operated, which may be used to determine the estimated remaining time ETR. The determining of how much of the cycle has been completed may be determined based on measuring the time that has elapsed since the start of the cycle. This data and video images may also be used to determine which step the crane currently performs as well as how far into this current step the operation of the crane has progressed.

Thereby the container lifting management function determines a current step of the operations cycle that the crane currently performs or operates in and how much of the current step the crane has completed based on the sensor data, S130.

The progress at the current point in time is then indicated in the representation of the current step of in the progress indicator PI, S140. This may be done through signaling how far into the current step the crane has progressed, for instance through a second vertical line that moves along the first horizontal progression line during the performance of the different steps, which movement may be from left to right. This second vertical line may be complemented by a symbol representing at least a part of the crane, such as a symbol representing the crane spreader, which symbol may be moved together with the second vertical line along the first horizontal progression line. Thereby, the symbol of the spreader may also be used to indicate the progress at the current point in time. This symbol may be used in addition to or instead of the second line.

The container lifting management function may additionally indicate the current step in the progress indicator P. In the example of FIG. 6, the current step is indicated through a third line above and in parallel with the first horizontal progression line and bordering an upper edge of the rectangular area of the current step.

The displaying being perfomed may also involve displaying the move number MN, move type MT, container CTR and target placing area environment TPAE of the container. This data may be obtained from the above-described work order.

The steps that have been completed, and the part of the current step that has been completed, may also be signaled, for instance through a special color such as green, while the remaining steps and the part of the current step that remains may be signaled through another color, such as grey.

Optionally, the container lifting management function may also identify and display, S150, the video stream that is linked to the current step, which in the current example is the fourth video stream VS4. The video stream may be displayed between the current move window CMW and the target lifting area environment TLAE.

After the above-mentioned current status has been signaled to the operator, the container lifting management function may investigate if the cycle has been completed, and if it has not, S160, then new sensor data is obtained, S120, current step determined, S130, indicated, S140, in the progress indicator and the video stream that is linked to the current step identified and displayed, S150, while if the cycle is completed, S160, operation is ended, S170. The above-described operation can be performed for all cycles of the work order.

It can in this way be seen that a good overview may be provided for a crane in a compact way. This can be combined with similar views for other cranes being supervised by the operator, which simplifies the monitoring of the progress of each crane. It can thus be seen that different types of industrial specific operational data are gathered, processed, and represented in an HMI thereby providing a supervisory view necessary for continuous monitoring and intervention. The information may be displayed on an RCS (Remote control station) or other devices that have display functionality.

Put differently, the operational process for a crane may be separated into moves containing various steps. The division may be based on predetermined action mapping. The mapping is shown in the progress indicator like for example a horizontal bar chart with sections. The progress indicator is associated with a crane move, often defined for example as moving a container from a quay to a vessel. The exact specification definition of a move may be retrieved from the work order.

The progress indicator may be complemented with additional information that is visualized in another area located in proximity to the progress indicator. The progress indicator and complementing infomation area may be linked and updated continuously as the crane operates. Thus, there may be provided an indication of the course of action planned and performed by a crane along with relevant information.

The operational process of a move may thus be separated into a number of steps or sections that each consist of one or multiple actions that a crane performs or plans to perform. The actions are gathered and processed from various data obtained from the crane control device and the video capturing system associated with the crane. Each section or step is thereafter united in a condensed progress indication, for example a horizontal bar, but not limited to, that in an easy and comprehensive way illustrates the progress of the crane. Each section can be complemented with symbols, for example in the form of icons, to facilitate seeing the type of action/job the crane is performing. The symbols are not limited to icons. Any type of graphical means (text, animations, etc.) can be used.

The progress indicator is associated with a crane move that may be defined in a work order, which work order may be retrieved from a workorder database. For each move the container lifting management function may estimate how long the cycle should take, and how much time is remaining to complete the move. It may also be able to break down a move into distinct sub-action based on predetermined mapping. This information is displayed in the progress indicator.

The progress indicator may also visualize the location of the spreader, for example if it is located over the quay or over the cargo vessel. This may be done by increasing the progress indicator area in any dimension, illustrating height differences.

Additionally, complementing infonnation may be visualized in proximity to the operational progress indicator. The current move window may display detailed infornation about the current operations that the crane is performing and updates in synchronization with the progress indicator.

The progress indicator with relevant information may thus be contained in a graphical element, here the current move window, making it easy to spot and understand. Any type of graphical elements or visualization techniques can be used to "contain" the progress indicator with its' relevant information. The current move window may thus represent various data types using any graphical means. The progress indicator may be refreshed/updated with new moves until all moves in the workorder are finalized.

The video stream may provide a good view of the current step. The container lifting management function may thus read various data about the crane operations and continuously refresh/update the progress indicator as the operations progresses. The progress indicator may be updated continuously with consecutive moves and may stop updating when no further moves remain. The progress indicator may thus be refreshed/updated with new moves until all moves in the workorder are finalized.

The progress indicator has a number of advantages. It is easy to comprehend and provides a condensed visualization that facilitates good overview of operational process for a crane. Thereby the operator is allowed to better understand the status and process of a crane.

The display of the video stream provides further help to the operator in monitoring the current step. There may be issues occurring during the automatic crane operation. It is for instance possible that the wrong container is being picked up. There may also be issues with hatch covers. These may be closed when they are supposed to be open, or vice versa. They may also be locked when they should be unlocked or vice versa. There may also be issues with twist locks or spreader flippers. A twist lock may be locked when it should not, and a spreader flipper may have the wrong orientation. It is also possible that people may be discovered in safety zones, such as safety zones around areas such as target areas where containers are to be placed or from where they are to be lifted.

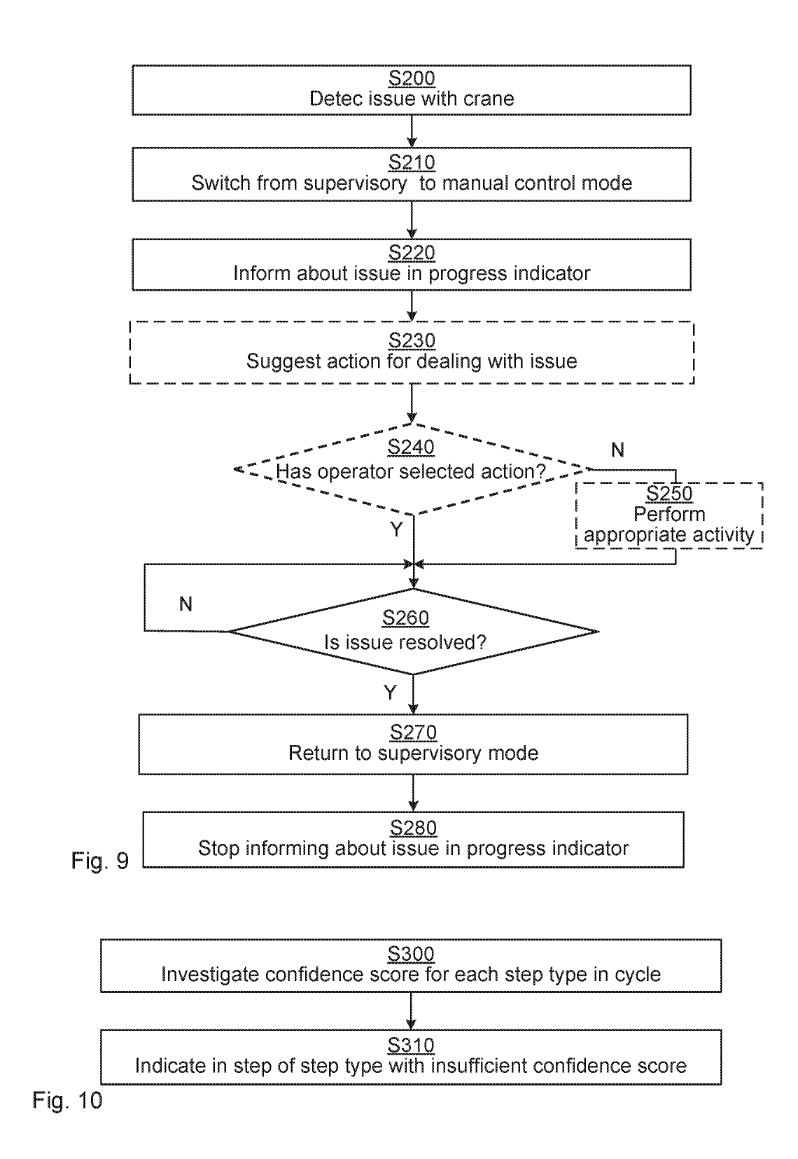

Aspects of the present disclosure are directed towards assisting an operator to handle such issues. How this can be done will now be described with reference being made to FIG. 8 and 9, where FIG. 8 schematically shows the progress indicator for the crane presented to the operator by the container lifting management device in a manual intervention mode, and FIG. 9 shows a flow chart of a second number of further method steps in the method of assisting an operator to handle the crane of the container lifting system. An issue may thus occur in relation to the crane.

It is possible that the wrong container has been lifted. A container may additionally have the wrong orientation during the move, for instance because of wind. This may stop it from being placed at the corresponding target placing area. As another example, the twist lock of a container that is to be lifted from a target lifting area may accidentally be locked to an underlying surface, such as to the deck, another container or a road chassis. It is also possible that there are people inside the safety zone around a target area. It is also possible that the target area is inside a hatch, the covers of which are not open. They may even be locked. All these situations are examples of issues that may occur. Aspects of the present disclosure are directed towards assisting a crane operator to handle such issues.

The container lifting management function may initially provide the supervisory mode where each crane in the group is controlled by a corresponding crane control device and where a supervisory view of the group of cranes is displayed to the operator, which supervisory view may display progress indicators of all the cranes in the group. In this mode each crane in the group is controlled by a corresponding crane control device in the group of crane control devices 16A, 16B, 16C, 16D. It is also possible that the video stream associated with the current step and the target area environment are being displayed.

The detecting of an issue may comprise obtaining data from the crane control device and/or video capturing arrangement, analyzing the data and determining the issue based on the analysis.

The container lifting management function may then detect, at the current point in time, that there is an issue with one of the cranes, S200, which as an example may be the first crane 18A. A detection may thus be made at the current point in time that there is an issue with the first crane 18A. The container lifting management function may obtain data from the crane control devices and/or video capturing arrangements, analyze this data and determine the issue based on the analysis. The data may comprise signals from the crane control devices, such as detected wind speeds, crane positions and crane movement speeds as well as images from the different video capturing systems, which images may then be analyzed. An issue may then be identified via the images and/or through investigating the signals received from the crane control devices. It is also possible that the container lifting management device 12 receives positions of persons around the target area, for instance through GPS transmitters on the persons or position signals transmitted by wireless terminals of these persons. Such a position can then be compared with the target position of a currently handled container to determine if the position is within the safety zone of the currently handled container. Alternatively, the presence of a person may also be detected in a video stream of the video capturing system.

Moreover, when an issue is detected for a crane, the container lifting management function may also determine in which step the issue is detected, which may be done through determining the position and direction of movement of the crane and/or the position and direction of movement of the spreader and knowledge about the positions of the quay and container vessel. It is also possible to consider the current time and the estimated remaining time of the cycle. The step may be determined through analysis of the video streams and/or position and speed signals associated with the crane provided by the crane control device.

When an issue is detected for a crane, there is a switch from automatic to manual control of the crane, 5210. The crane that experiences the issue is thus switched from being operated in supervisory mode to being operated in the manual control mode, in which it is controlled by the operator. There is thus a switch from the crane being controlled by the corresponding crane control device to manual control by the operator The container lifting management function may for instance put the automatic control performed by the corresponding crane control device on hold and instead hand over control to the operator. The crane experiencing the issue may thus in this case be controlled by the operator instead of the corresponding crane control device. The container lifting management function then inforns the operator about the issue in the progress indicator of the crane, S220, which may be done in the current step of the progress indicator PI. The container lifting management function may thus display that there is an issue to the operator in the representation of the current step in the progress indicator PI.

As an example, there may be an issue with the first crane 18A, which may be signaled in the progress indicator PI shown in FIG. 8. At least a part of the rectangle representing the current step may then signal the issue, for instance through another color such as yellow or red. It is here possible that the part of the current step that has already been performed is influenced in this way, as may the horizontal line on the upper edge of the rectangle. The vertical line representing the progress of the crane/spreader may receive the same or yet another color. For instance, if one is yellow, the other may be red.

It is here possible that the progress indicator PI signals the issue in the current step as well as possibly in a following step. This signaling can be made through highlighting or a special color of parts of the squared shape area that have been covered in the current step and through providing a line with the same highlighting or color above the rest of this square shaped area and the square shaped area of one or more following steps.

The operator can be further informed of the issue through the displayed video stream that is associated with the current step. The view of the current destination target area environment may in this case be changed. If the spreader SP is close to the current target area also the location of the spreader SP in relation to the current target area may be indicated. The current target area may be displayed together with the previous and following target areas. Also, the safety zone SZ around the current target area may be indicated, which safety zone may pass through the following target areas in the neighborhood of the current target area. It is possible that the safety zone covers the current target area and neighboring previous target areas as well as goes through the following target areas that border the current target area.

As an example, a container may have failed to be set down in the target area and a reason for this is that persons have been detected inside the safety zone SZ. Thus, the crane 18A is supposed to handle a container at a current target area. However, the container lifting management function has detected positions of people at or around the current target area and these positions are such that one or more persons are located within the safety zone around the current target area, where additionally the safety zone SZ passes through a number of neighboring target areas that are to be handled in following cycles.

The container lifting management function may additionally determine a person at or around the current target area that is to handle the issue and also set up a communication session between the operator and this person.

As an example, the target area may be on a deck of the container vessel and the recommendation may be to connect to the closest person with manager duties, which is here a deckman. The position of the person P1 detected inside the safety zone SZ as well as the position of the deckman P2 may also be displayed. As an example, these positions are displayed in relation to the target lifting area environment TLAE.

The positions of the people can be obtained using positioning services, such as GPS. It is also possible to detect positions of persons in one or more video streams using image recognition. The deckman may additionally be equipped with a cellular phone, for instance a smartphone and a communication session may be set up between the operator and the deckman via the container lifting management device and the terminal of the deck man. Information about the deckman may be obtained from a database.

As an issue is detected, about one the cranes, S200, the container lifting management device 12 thus switches from automatic to manual control of this crane, S210, as well as informs about the issue in the progress indicator of the crane, S220.

The container lifting management function may also suggest at least one action for dealing with the issue, S230. The container-lifting management function may thus provide recommendations to the operator for handling the issue. As an example, one such recommendation may be to connect to the closest deckman P2.

The container lifting management device may investigate whether the operator has selected the action, S240, and perform an appropriate activity in case the operator has not, S250. One appropriate activity may be to wait until the operator has performed the action. Another may be to suggest an alternative action.

After the operator has performed the original or alternative action, the container lifting management function continues and investigates if the issue has been resolved. This check is also made if no investigations are made concerning operator action selection. In case the issue has not been resolved, S260, it is possible to return and wait until it has. If the issue has been resolved, S260, for instance through no person any longer being in the safety zone SZ, the container lifting management function may return to the supervisory mode where the crane is automatically controlled, S270, which may be done based on a confirmation by the operator that the issue has been resolved. The signaling of the issue in the progress indicator is also stopped, S280.

Moreover, after the completion of each cycle, the container lifting management function may store data in the step database 20. For each step and step type it may make a setting of if there was an issue or not. If there was an issue, it is also possible to indicate the issue type. Thus, it is possible to provide a classification of issues according to issue type. Each issue type may have complexity, i.e., requires a certain skill for being handled. There may also be an associated time for handling the issue type.

It can in this way be seen that an operator is assisted in resolving an issue. The switch from the supervisory mode to the manual intervention mode may additionally be fast when an issue is encountered and thereby it is possible that dangerous situations are avoided. Moreover, through the storing of settings of if there is an issue or not, a step database can be built up that provides statistics about how prone the different types of steps are to issues as well as the different types of issues that can occur in a step, which types can be of different severities and require different skills for their handling.

In the example given above, the function was reactive. It thus reacted on a detected issue. It should be realized that it is just as well possible to use the progress indicator to signal a possible issue to the operator. It is thus possible to signal to the user that an issue may occur in a step, which may then be used by the operator to switch to manual control mode if he or she deems it to be necessary. Alternatively, it is possible to automatically switch to a manual control mode, if it is envisaged that a step may face an issue and then automatically return to the supervisory mode in case no issue is detected.

How this can be handled with now be described with reference being made to FIGS. 8 and 10, where FIG. 10 shows a flow chart of a third number of further method steps in the method of assisting an operator to handle the crane of the container lifting system

The different step types may have confidence scores. These scores may be calculated based on how prone to issues the steps of the corresponding type are, which may be based on an issue probability determined based on the number of issues stored for the step type in the step database.

When the confidence score for a step is calculated an identification of steps that might require human intervention may also be made. If the coming steps are in need of human intervention, they may be highlighted in the progress indicator and thereby they may draw operator's attention and increasing awareness well in advance so that the operator is ready to intervene without any lag. The detection that certain actions require human intervention could be determined based on frequency of past failure or based on the confidence score calculated by the system for successful completion of the task. The same type of progress bar that is shown in FIG. 8 may be used for this purpose. Each step in the cycle may be of a different type and each step type may have a corresponding confidence score.

A confidence score may be calculated as a probability of how issue prone the step type is. Thus, a confidence score may provide a probability of an issue for the step type. This can be done through dividing the number of times the step type has had an issue with the total number of times the step type has been performed. Alternatively, the probability can be calculated through dividing the number of times the step type has been correctly performed with the total number of times the step has been performed.

In this case, the method may further comprise investigating, for each step, the confidence score of the corresponding step type, S300, which investigating may involve comparing the confidence score of a step type with a corresponding confidence score threshold and determining that the confidence score is insufficient if the confidence score is above or below the confidence score threshold. Typically, a confidence score may be detenmined to be insufficient if it is below the corresponding confidence score threshold. Alternatively, a confidence score may be insufficient if it is above the corresponding confidence score threshold.

After a confidence score for a step type has been found to be insufficient, this may be indicated in the representation of the step of this step type, S310, which indication may be made in the representation of the step when it becomes the current step. For a step that has an insufficient confidence score, it is additionally possible to provide indications of the probable complexity or required time to solve it.

As was mentioned earlier, the different issues that can occur in a step type may be classified according to type and for each type it is possible to indicate the skill set required to solve it, for instance defined as a role, and/or the time required to solve it. The different step types may be linked to indications of probable complexity and/or time consumption for issue handling. The different issues that can occur in a step type may be classified according to type of issue.

An indication may be provided as a probability that the issue is of a corresponding issue type. For each type of issue it is possible to indicate the skill set required to solve it, for instance defined as a role, and/or the time required to solve it.

An indication of probable complexity may provide a probability that the issue is of a certain issue type as well as an indication of how complex this issue type is and/or time consuming the handling of the issue type is.

It is possible to determine the different percentages of the classifications and present them to the operator. When the confidence score of a step has failed, it is thus possible to present probabilities for the different possible issue type classifications. It is also possible to present the operator with information about what type of classification the possible issue most likely has as well as the skill set and/or the time required to handle it. The operator may also prepare for the type of intervention that may be required in advance. This can be used for allowing the appropriate person to be at standby. There may additionally be a switching from the supervisory mode to manual control mode when the step for which the step type has an insufficient confidence score becomes the current step. This has the advantage of allowing an unsafe situation to be resolved fast, since the operator is notified about it early, giving him or her an increased time for preparation.

In the context of the present disclosure, the determining of how much of the current step the crane has completed may be a determining of how much of the current step the crane has completed at the current point in time. The container lifting system may further comprise a video capturing system associated with the crane. The video capturing system may comprise a number of video cameras at least one of which is mounted on the crane.

The steps may be shown as a number of rectangular shaped areas provided along a first line and the progress at the current point in time may be indicated using a second line that is perpendicular to the first line. The second line may for instance be a vertical line that moves along a horizontal first line during the consecutive steps in the cycle. The movement of the second line may be from left to right.

Each step may be shown as having one of two heights or levels above the first line, where a first height or level above the first line indicates that the crane is above a quay and a second height or level above the first line indicates that the crane is above a cargo vessel or vice versa.

The progress indicator may further comprise symbols representing at least some of the steps. These symbols may be shown in the rectangular shaped areas of these steps. The symbols may for instance be realized as icons.

The crane may have a spreader and a symbol of this spreader may be used to indicate the progress at the current point in time. This symbol may be used in addition to or instead of the second line.

The method may further comprise indicating the current step in the progress indicator and the container lifting management device may be further operative to indicate the current step in the progress indicator.

The video capturing system may provide a number of video streams, where at least some of the steps performed by the crane in the operations cycle are linked to video streams. A step may be linked to a video stream. It may more particularly be linked to only one video stream. In this case, the method may further comprise identifying and displaying a video stream that is linked to the current step. In the above-mentioned case the container lifting management device may be further operative to identify and display the video stream that is linked to the current step.

At least some of the steps in the cycle may be of different types and each step type may have a corresponding confidence score. A confidence score may provide a probability of an issue for the step type. In this case, the method may further comprise investigating, for each step, the confidence score of the corresponding step type and indicating in the representation of the step when the step type has a confidence score that is insufficient. In this case, the container lifting management device may be further operative to investigate, for each step, the confidence score of the corresponding step type and indicate in the representation of the step when the step type has a confidence score that is insufficient.

The investigating of the confidence score may comprise comparing the confidence score of a step type with a corresponding confidence score threshold and determining that the confidence score is insufficient if the confidence score is above or below the confidence score threshold. The step for which the step type has a confidence score that is insufficient may be indicated when the step becomes the current step. The different step types may be linked to indications of probable complexity and/or time consumption for issue handling.

The different issues that can occur in a step type may be classified according to type of issue. An indication may be provided as a probability that the issue is of a corresponding issue type. For each type of issue it is possible to indicate the skill set required to solve it, for instance defined as a role, and/or the time required to solve it.

An indication of probable complexity may provide a probability that the issue is of a certain issue type as well as an indication of how complex this issue type is and/or time consuming the handling of the issue type is.

Furthermore, the crane may initially operated in a supervisory mode, where it is controlled by a corresponding crane control device. In this case, the method may further comprise switching from the supervisory mode to manual control mode when the step for which the step type has an insufficient confidence score becomes the current step, in which manual control mode the crane is controlled by the operator. In this case, the container lifting management device may be further operative to switch from the supervisory mode to manual control mode when the step for which the step type has an insufficient confidence score becomes the current step, in which manual control mode the crane is controlled by the operator.

When the crane is initially operated in a supervisory mode, the method may further comprise detecting an issue with the crane at the current point in time, switching from the supervisory mode to manual control mode based on the detecting of the issue, in which manual control mode the crane is controlled by the operator, and displaying that there is an issue to the operator in the representation of the current step in the progress indicator. In this case the container lifting management device may be further operative to detect an issue with the crane at the current point in time, switch from the supervisory mode to manual control mode based on the detecting of the issue, in which manual control mode the crane is controlled by the operator, and display that there is an issue to the operator in the representation of the current step in the progress indicator.

The detecting of an issue may comprise obtaining data from the crane control device and/or video capturing arrangement, analyzing the data and determining the issue based on the analysis.

The method may additionally comprise providing recommendations to the operator for handling the issue and the container lifting management device may be further operative to provide recommendations to the operator for handling the issue.

The crane may be set to handle a container in a current target area in the operations cycle. In this case the method may further comprise displaying the target area together with previous and following target areas and a safety zone. In this case the container lifting management device may be further operative to display the target area together with previous and following target areas and a safety zone.

The issue may be that one or more persons are located within the safety zone around the current target area. In this case the method may further comprise determining a person at or around the current target area that is to handle the issue and setting up a communication session between the operator and this person. In this case the container lifting management device may be further operative to determine a person at or around the current target area that is to handle the issue and set up a communication session between the operator and this person.

All references, including publications, patent applications, and patents, cited herein are hereby incorporated by reference to the same extent as if each reference were individually and specifically indicated to be incorporated by reference and were set forth in its entirety herein.

The use of the terms "a" and "an" and "the" and "at least one" and similar referents in the context of describing the invention (especially in the context of the following claims) are to be construed to cover both the singular and the plural, unless otherwise indicated herein or clearly contradicted by context. The use of the term "at least one" followed by a list of one or more items (for example, "at least one of A and B") is to be construed to mean one item selected from the listed items (A or B) or any combination of two or more of the listed items (A and B), unless otherwise indicated herein or clearly contradicted by context. The terms "comprising," "having," "including," and "containing" are to be construed as open-ended terms (i.e., meaning "including, but not limited to,") unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., "such as") provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method for assisting an operator to handle a crane of a container lifting system, the method being performed by a container lifting management device and comprising:
displaying a progress indicator to the operator, the progress indicator showing representations of one or more sequential steps being performed by the crane in an operations cycle;
obtaining sensor data of the crane at a current point in time during the operations cycle;
determining a current step of the operations cycle that the crane currently performs and how much of the current step the crane has completed based on the sensor data; and
indicating a progress at the current point in time in the representation of the current step of the progress indicator.

2. The method of claim 1, wherein the steps are shown as a number of rectangular shaped areas provided along a first line and the progress at the current point in time is indicated using a second line that is perpendicular to the first line.

3. The method of claim 1, wherein each step is shown as having one of two heights above the first line, where a first height above the first line indicates that the crane is above a quay and a second height above the first line indicates that the crane is above a cargo vessel.

4. The method of claim 3, wherein the progress indicator further comprises symbols representing at least some of the steps.

5. The method of claim 1, wherein the crane has a spreader, a symbol of which is used to indicate the progress at the current point in time.

6. The method of claim 1, wherein each step in the cycle is of a different type, and wherein each step type has a corresponding confidence score.

7. The method of claim 6, further comprising investigating for each step the confidence score of the corresponding step type and indicating in the representation of the step when the step type has a confidence score that is insufficient.

8. The method of claim 7, wherein the step for which the step type has a confidence score that is insufficient is indicated when the step becomes the current step.

9. The method of claim 8, wherein the crane is initially operated in a supervisory mode, where it is controlled by a corresponding crane control device.

10. The method of claim 9, further comprising switching from the supervisory mode to a manual control mode when the step for which the step type has an insufficient confidence score becomes the current step, and wherein the crane is controlled by an operator in the manual control mode.

11. The method of claim 9, further comprising detecting an issue with the crane at the current point in time, and switching from the supervisory mode to a manual control mode based on the detecting of the issue, wherein the crane is controlled by an operator in the manual control mode.

12. The method of claim 11, further comprising displaying the issue to the operator in the representation of the current step in the progress indicator.

13. The method of claim 1, wherein the crane is set to handle a container in a current target area in the operations cycle, and wherein the method further comprises displaying the target area together with previous and following target areas and a safety zone.

14. The method of claim 13, wherein the issue is that one or more persons are located within the safety zone around the current target area, and wherein the method further comprises determining a person at or around the current target area that is to handle the issue and setting up a communication session between the operator and this person.

15. The method of claim 1, wherein the container lifting system comprises a video capturing system associated with the crane, wherein the video capturing system provides one or more video streams, wherein at least some of the steps are linked to a corresponding video
stream, and wherein the method further comprises identifying and displaying the video stream that is linked to the current step.

16. A container lifting management device comprising a processor operative to:
display a progress indicator to an operator, which progress indicator shows representations of a number of sequential steps being performed by a crane in an operations cycle;
obtain sensor data of the crane at a current point in time during the operations cycle;
determine a current step of the operations cycle that the crane currently performs and how much of the current step the crane has completed based on the sensor data; and
indicate the progress at the current point in time in the representation of the current step of the progress indicator.

17. A computer program for assisting an operator to handle a crane of a container lifting system, the computer program comprising computer program code which when run by a processor causes the processor to:
display a progress indicator to an operator, which progress indicator shows representations of a number of sequential steps being performed by the crane in an operations cycle;
obtain sensor data of the crane at a current point in time during the operations cycle;
determine a current step of the operations cycle that the crane currently performs and how much of the current step the crane has completed based on the sensor data; and
indicate the progress at the current point in time in the representation of the current step of the progress indicator.
